(19) United States
(12) Patent Application Publication
(10) Pub. No.: US 2009/0004358 A1
(43) Pub. Date: Jan. 1, 2009

(54) Method of Producing and Administering a Nutritional Supplement Including Sunflower Butter

(76) Inventor: Jeffrey W. Evenson, Bismarck, ND (US)

Correspondence Address: NEUSTEL LAW OFFICES, LTD., 2534 SOUTH UNIVERSITY DRIVE, SUITE 4, FARGO, ND, 58103, US

(21) Appl. No.: 11/770,208

(22) Filed: Jun. 28, 2007

(51) Int. Cl. A23L 1/00; A23C 9/16; A23L 1/09; A23D 9/007

(52) U.S. Cl. 426/588; 426/601; 426/613; 426/615

(57) ABSTRACT

A method of producing and administering a nutritional supplement including sunflower butter for efficiently treating a malnourished individual. The method of producing and administering a nutritional supplement including sunflower butter generally includes a supplement including a sunflower butter substance, wherein the sunflower butter substance is mixed with various micro-nutrients within the supplement and wherein the supplement comprises a substantial portion of a recommended daily allowance of food for an individual.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to therapeutic substances and more specifically it relates to a method of producing and administering a nutritional supplement including sunflower butter for efficiently treating a malnourished individual.

2. Description of the Related Art

Any discussion of the prior art throughout the specification should in no way be considered as an admission that such prior art is widely known or forms part of common general knowledge in the field.

Therapeutic substances have been in use for years. Typically, therapeutic substances and nutritional supplements are utilized for various purposes associated with various medical treatments. A common treatment, especially in third world countries, is treating malnourished individuals.

The science of malnourishment (i.e. starvation) in recent years has focused on the low nutrient levels (e.g. macro-nutrients and micro-nutrients) needed in the human body. This science looks at the micro-nutrient losses during starvation and the options for replenishment. When children are starving they are usually dehydrated as well, wherein re-hydration generally should commence with feeding.

Low levels of micro-nutrients generally weaken the immune system thus allowing for predictable diseases to settle in. The diseases of micro-nutrient deficiencies range from Goiter, due to lack of adequate levels of iodine, to Scurvy, due to lack of Vitamin C, and many others, wherein these diseases can affect many people throughout the world.

Therapeutic foods generally encompass a wide range of foods designed for people who are suffering from moderate, acute, and severe malnutrition. F-75 is a fortified dried skim milk supplement as is F-100. A fortified porridge, called UNIMIX, is also served with a high energy/high protein biscuit. The problem with dried milk is that water is needed. In the congested, dust filled refugee camps, water is easily contaminated. The spoilage rate of the newly mixed milk in over 100 degree desert heat is high.

Another popular therapeutic food is PLUMPY NUT. It is an oily fortified peanut butter paste in a sealed sachet that is being fed to malnourished children in refugee camps. The oil reduces oxidation levels to the point where the shelf life can be extended with stabilizers up to 2 years. PLUMPY NUT needs no water, no refrigeration, and is not a bacteria medium. The dry material of the ration has to be below 10% moisture and below 5% moisture is even better. Many people, however, have been known to be allergic to various types of nuts and nut related substances (i.e. peanuts).

Sunflowers and sunflower related substances (e.g. butter, paste, seeds, etc.) have been around for some time. Sunflower butter has not been a popular spread for consumers for various reasons, such as but not limited to the unpleasant taste. However, in recent years, various studies and experiments have found solutions to the unpleasant taste of sunflower butter. There is the need for a new and improved method of producing and administering a nutritional supplement including sunflower butter for efficiently treating a malnourished individual.

### BRIEF SUMMARY OF THE INVENTION

The general purpose of the present invention is to provide a method of producing and administering a nutritional supplement including sunflower butter that has many of the advantages of the therapeutic substances mentioned heretofore. The invention generally relates to a therapeutic substance which includes a supplement including a sunflower butter substance, wherein the sunflower butter substance is mixed with various micro-nutrients within the supplement and wherein the supplement comprises a substantial portion of a recommended daily allowance of food for an individual.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a method of producing and administering a nutritional supplement including sunflower butter for efficiently treating a malnourished individual.

Another object is to provide a method of producing and administering a nutritional supplement including sunflower butter that is good tasting.

An additional object is to provide a method of producing and administering a nutritional supplement including sunflower butter that may be utilized as a therapeutic treatment.

A further object is to provide a method of producing and administering a nutritional supplement including sunflower butter that is ready to use within the packaging.

Another object is to provide a method of producing and administering a nutritional supplement including sunflower butter that does not need to be mixed with water.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view illustrating a family pack and a plurality of containers each including a dosage of the supplement within the family pack.

FIG. 2 is an flow chart illustrating the process of producing the supplement.

### DETAILED DESCRIPTION OF THE INVENTION

### A. Overview

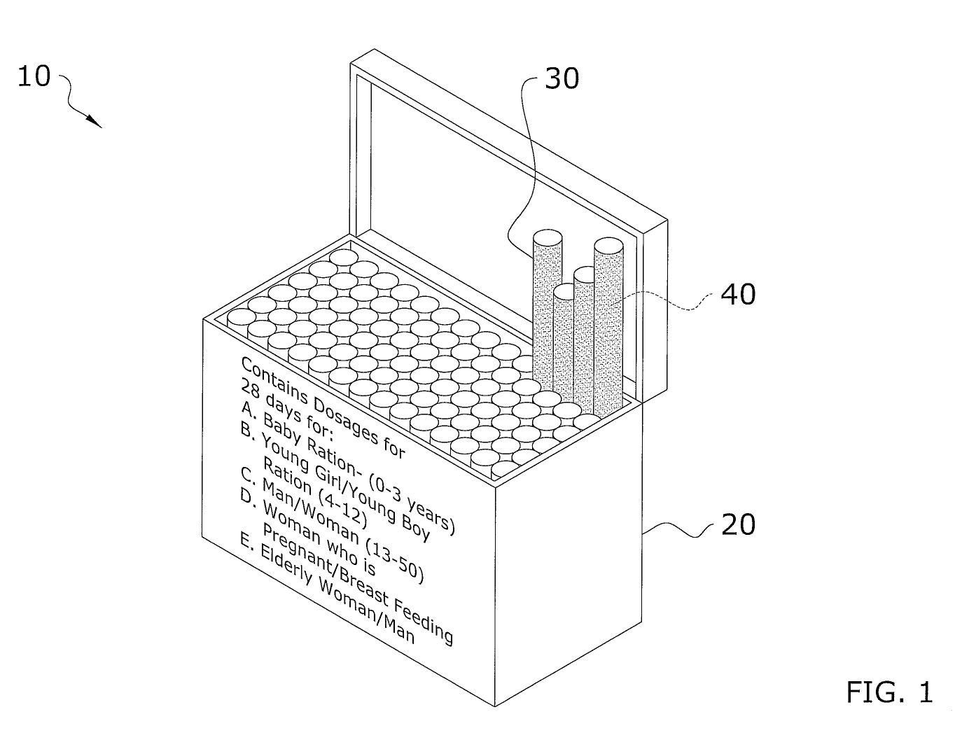

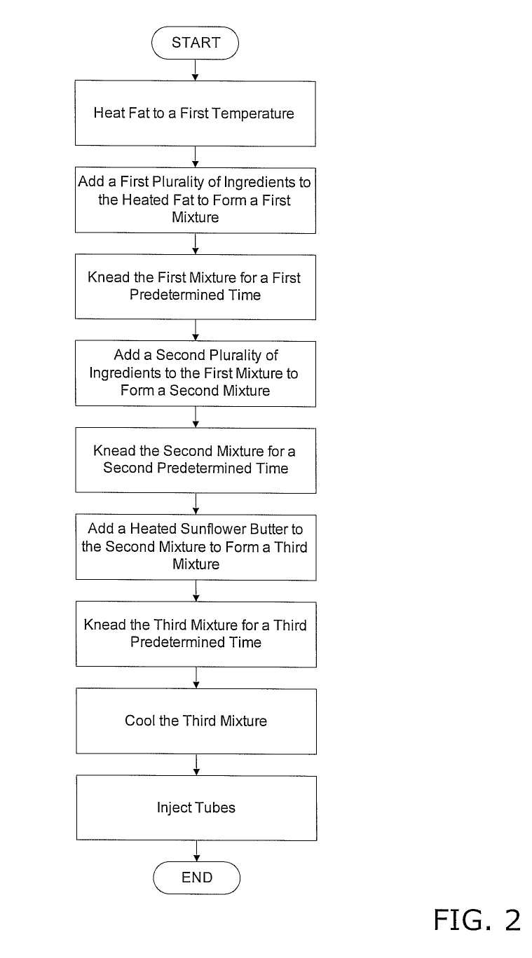

Turning now descriptively to the drawings, in which similar reference characters denote similar elements throughout the several views, FIGS. 1 and 2 illustrate a method of producing and administering a nutritional supplement 10, which comprises a supplement 40 including a sunflower butter substance, wherein the sunflower butter substance is mixed with various micro-nutrients within the supplement 40 and wherein the supplement 40 comprises substantial portion of a recommended daily allowance of food for an individual. U.S. Pat. No. 6,346,284 illustrates a supplement that may be utilized to treat malnourished individuals and is hereby incorporated by reference herein.

### B. Producing the Preferred Embodiment

The supplement 40 is preferably comprised of a pourable form. The supplement 40 is also preferably adjusted in the amount of micro-nutrients added to adjust for differing individual/nourishment types (i.e. very malnourished, differing ages, pregnant women, etc.).

i. Sunflower Butter Paste

Following is the preferred composition and producing process of the sunflower butter paste, wherein the description of sunflower butter paste is also described in “Optimization Analysis of Sunflower Butter” by Guraya, H. S. and Lima, I. M. in the Journal of Science 2005 (Vol. 70) (No. 6). It is appreciated however that the sunflower butter paste may be produced in various manners or utilize various ingredients not listed or described within this description.

The supplement 40 includes sunflower butter paste, wherein the composition of the sunflower butter paste is as follows: 90% sunflower seeds (i.e. dried to less than 5% moisture), 7% sugar, 1.1% salt and 1.8% stabilizer. It is appreciated that the sunflower seeds utilized with the present invention also have the shell and translucent outer coat removed.

The sunflower butter paste is formed from the composition as follows: roasting the sunflower seeds in soybean oil (i.e. a blend of both cottonseed oils and hydrogenated rapeseed), placing ingredients (i.e. sunflower seeds, sugar, salt, stabilizer) in a vertical-cutter mixer, mixing the ingredients at 1500 rpms (revolutions per minute) for 2 minutes, further mixing the ingredients at 3000 rpms for 16 minutes and further mixing the ingredients at 1500 rpms for 2 minutes.

ii. Supplement

Following are the mixing instructions for the supplement 40 utilized with the present invention. It is noted to first mix the warm oil with the vitamins and minerals. Then, the fortified oil supplement is spread throughout the remaining ingredients to form a more homogenous blend. The ingredients and amounts utilized within the mixing instructions are also summarized below in Table 1 and Table 2:

TABLE 1

| Ingredients | Amount (kg) |
|---|---|
| Fat (i.e. Canola Oil) | 40 |
| Sugar | 9.7 |
| Vitamins & Minerals* | 1 |
| Fortified Dried Skim Milk | 25 |
| Whey | 25 |
| Maltodextrin | 25 |
| Sunflower Butter Paste | 40 |

*See Table 2 for a more detailed list of the Vitamins and Minerals utilized within the supplement 40.

TABLE 2

| | Amount |
|---|---|
| Ingredients | (in grams per 600 grams) |
| Vitamin A | 8.68 |
| Vitamin D | 5.04 |
| Vitamin E | 31.50 |
| Vitamin C | 45.53 |
| Vitamin B1 - Thiamin | 0.47 |
| Vitamin B2 - Riboflavin | 1.42 |
| Vitamin B6 - Pyridoxine | 0.47 |
| Vitamin B12 - Cyanocobalamin | 0.42 |
| Vitamin B9 - Folic Acid | 0.17 |
| Vitamin PP - Nicotinamide | 4.17 |
| Vitamin B5 - Pantothenic Acid | 2.44 |
| Vitamin B8 - Biotin | 0.05 |
| Vitamin K | 0.33 |
| Zinc Oxide (micro-encapsulated) | 9.30 |
| Calcium Phosphate | 93.06 |
| Copper Sulfate* | 0 |
| Potassium Chloride | 393.71 |

*Sunflower butter paste is high in Copper Sulfate, thus the amount of Copper Sulfate added to the supplement 40 may vary depending on who the supplement 40 is administered to (i.e. children would require less Copper Sulfate than adults).

The fat (e.g. canola oil, etc.) is heated to a first temperature, wherein the first temperature is preferably approximately 145 degrees Fahrenheit. It is appreciated that the first temperature may vary slightly to accommodate for various cooking preferences. The fat is also preferably heated within a kneading machine, wherein the heat is provided by an external water jacket.

A first plurality of ingredients are then added to the heated fat within the kneading machine. The first plurality of ingredients preferably include various vitamins, minerals, stabilizers, digestive enzymes and digestive aiding bacteria. The digestive enzymes preferably include amulase, protease, lipase and cellulasse. The two primary enzymes are digestive enzymes and metabolic enzymes. Enzymes are essential to the body's absorption and full use of food. The primary digestive enzymes are amylases (to digest carbohydrate), proteases (to digest protein), and lipases (to digest fat).

These enzymes function as a biological catalyst to help break down food. These enzymes are present in the ration of the dosages of the supplements 40 during the entire treatment period. The lipase is microencapsulated since the entire dosage is covered with a lipid oil. The lipase is microencapsulated to prevent the body from breaking down until it reaches the large intestine. The digestive aiding bacteria preferably includes lactobacillus acidophilus, bifidobacterium bifidum, lactobacillus bulgaricus and streptococcus thermophilus.

The first plurality of ingredients and the fat are then kneaded for a first predetermined amount of time. In the preferred embodiment, the first plurality of ingredients and the fat are kneaded slowly (i.e. approximately 50 rpms) first for 5 minutes and then reversed kneaded for 2 minutes at 80 rpms to ensure a proper blend. It is appreciated that the air is prevented from entering the first plurality of ingredients and the fat during the kneading process.

A second plurality of ingredients are then added to the first mixture (i.e. first plurality of ingredients and fat) within the kneading machine. The second plurality of ingredients preferably include fortified skimmed milk powder, protein whey and maltodextrin. The second plurality of ingredients and the first mixture are then kneaded for a second predetermined amount of time. In the preferred embodiment, the second plurality of ingredients and the first mixture are kneaded at approximately 60 rpms for 4 minutes and then reversed kneaded for 4 minutes at 55 rpms to ensure a proper blend.

The sunflower butter paste is also heated to a second temperature at this time or prior to. The second temperature is preferably approximately 120 degrees Fahrenheit. After the sunflower butter paste is heated to the desired temperature, the sunflower butter paste is added the second mixture (i.e. second plurality of ingredients, first plurality of ingredients and fat) to form the supplement 40. In the preferred embodiment, the supplement 40 is kneaded at approximately 60 rpms for 4 minutes and then reversed kneaded for 3 minutes at 60 rpms to ensure a proper blend.

The heat may then be reduced upon the supplement 40 preferably by inserting cold water throughout the water jacket. The supplement 40 should now be comprised of a pourable substance. The supplement 40 is then preferably proportioned out and injected within the containers 30 for administering the supplement 40.

Differing amounts of nutrients may also be added to the supplement 40 depending on who the supplement 40 is to be administered to (i.e. infants, young adults, elderly, pregnant women, etc.). Below is a Table 3 illustrating an example of the differing amounts of nutrients to be added to supplement 40. The dosages of the supplement 40 are broken down into sex and age groups. It is appreciated that the nutritional needs of a pregnant woman are different from a growing child, hence, the need for different supplements 40 for the specific sex and age.

It is also appreciated that in Table 3, “1^{st} Weeks” stands for the first weeks of treatment with the supplement, “0-3 Years” indicates age of the individual being treated, “4-12 Years” indicates age of the individual being treated, “13-50 Years” indicates age of the individual being treated, “50+Years” indicates age of the individual being treated, and “Pregnant/Lactating Women” indicates women who are pregnant and/or lactating. It is appreciated that the respective categories (i.e. “0-3 Years”, “4-12 Years”, etc.) may be modified to accommodate differing levels of nourishment/current health of the individual being treated.

It is appreciated that the following data relies on the Reference Dietary Intake (RDI) generated from the United States Department of Agriculture (USDA) and may change depending on changes in the RDI, Recommended Daily Allowance (RDA) or USDA and/or varying requirements for treating malnourished individuals.

TABLE 3

| Nutrient (in | Amount | | | | | |
|---|---|---|---|---|---|---|
| mg, unless | | | | | | Pregnant/ |
| otherwise | 1^{st} | 0-3 | 4-12 | 13-50 | 50+ | Lactating |
| stated | Weeks | Years | Years | Years | Years | Women |
| Vitamin A | 200 | 400 | 500 | 800 | 500 | 975 |
| (ug/day) | | | | | | |
| Beta- | 0 | 5 | 5 | 5 | 5 | 5 |
| Carotene | | | | | | |
| (ug) | | | | | | |
| Vitamin E | 0 | 14.50 | 17.50 | 17.50 | 20 | 25 |
| Vitamin D | 5 | 5 | 5 | 10 | 5 | 10 |
| Vitamin C | 0 | 30 | 30 | 45 | 45 | 65 |
| Vitamin B1 | 0 | 0.44 | 0.56 | 1.0 | 1.0 | 1.4 |
| Vitamin B2 | 0 | 0 | 0.58 | 1.1 | 1.1 | 1.3 |
| Vitamin B3 | 0 | 0 | 0 | 7.0 | 7.0 | 10 |
| Vitamin B6 | 0 | 0.212 | 0.4 | 0.8 | 0.8 | 1.0 |
| Folate (ug) | 0 | 0 | 100 | 200 | 150 | 400 |
| Vitamin B12 | 0.25 | 0.42 | 0.57 | 1.1 | 1.1 | 1.4 |
| Vitamin B5 | 0 | 0 | 0 | 0 | 0 | 0 |
| Iron | 0 | 0 | 0 | 15 | 15 | 26 |
| Zinc | 0 | 0 | 0 | 0 | 0 | 0 |
| Copper | 0 | 0 | 5.5 | 6.5 | 5.5 | 8.5 |
| Calcium | 600 | 0 | 0 | 0 | 0 | 0 |
| Phosphate | | | | | | |
| Calcium | 0 | 350 | 650 | 900 | 900 | 900 |
| Carbonate | | | | | | |
| Selenium | 0 | 0 | 0 | 0 | 0 | 0 |
| Iodine (ug) | 60 | 75 | 75 | 115 | 115 | 150 |
| Sodium | 200 | 250 | 400 | 500 | 500 | 600 |
| Magnesium | 0 | 0 | 0 | 220 | 200 | 220 |
| Phosphorus | 0 | 0 | 0 | 1000 | 1000 | 1500 |
| Potassium | 0 | 0 | 0 | 1000 | 1000 | 1000 |
| Manganese | 0 | 0 | 0 | 2.0 | 2.0 | 2.5 |

It is appreciated that the amounts within Table 3 may vary and are only illustrative of the present invention combined with the RDI, wherein the amounts may vary depending on requirements of malnourished individuals. It is also appreciated that a daily amount of the supplement 40 accounts for approximately half of the Recommended Dietary Allowance (RDA) for a given individual, wherein the individual is still expected to eat a certain amount of food along with the supplement 40.

### C. Administering the Preferred Embodiment

When administering the present invention, the proportioned amount of the supplement 40 is injected within a container 30. The container 30 is preferably comprised of a squeezable configuration, wherein the individual utilizing the container 30 may squeeze the supplement 40 from the container 30 to within their mouth. The container 30 may also be opened in various manners, such as but not limited to tearing off a corner of the container 30. A family or group of individuals may also order a family pack 20 as illustrated in FIG. 1. The family pack 20 preferably includes enough containers 30 for the group of individuals/family to utilize for a given amount of time (e.g. 28 days, 1 month, 1 week, etc.).

The supplement 40 may be administered at various times throughout the day. In the preferred embodiment each container includes a single dosage of the supplement 40 and each container 30 is taken by mouth at morning and another container 30 at night. When first starting out utilizing the present invention (i.e. 1^{st} weeks upon Table 3) the containers 30 (i.e. morning doses, evening doses) may be portioned throughout the day so that the individual may acclimate their stomachs to the supplement 40 and eating food. Once the individual regains their appetite the supplement 40 may be administered at normal times (i.e. morning and night).

The “1^{st} Weeks” dosages of the supplement 40 are also preferably iron suppressed, wherein individuals that are severely malnourished are generally recommended not to induce large amounts of iron. It is also preferred that no food is eaten 1 hour before or 1 hour after the supplement 40 has been eaten (i.e. administered). The supplement 40 is also preferably taken with water (i.e. one glass per container 30) to suppress the iron within the supplement 40. The supplement 40 taken in the first week contains calcium phosphate which suppresses iron absorption (see Table 3). The supplement 40 taken in the subsequent weeks (after the first week) utilizes calcium carbonate instead of calcium phosphate because iron is better tolerated and is needed by the body in the subsequent weeks. It is also appreciated that the containers 30 may include writing or other labeling describing to the individual when and who should take the respective mixture within a container 30.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A method of producing and administering nutritional supplement including sunflower butter, comprising:
a supplement including a sunflower butter substance;
wherein said sunflower butter substance is mixed with various micro-nutrients within said supplement;
wherein said supplement comprises a substantial portion of a recommended daily allowance of food for an individual.

2. The method of producing and administering a nutritional supplement including sunflower butter of claim 1, wherein said supplement includes sugar, maltodextrin, protein whey, fortified milk powder and fat.

3. The method of producing and administering a nutritional supplement including sunflower butter of claim 1, wherein said supplement includes various digestive enzymes and digestive aiding bacteria.

4. The method of producing and administering a nutritional supplement including sunflower butter of claim 1, wherein said sunflower substance is comprised of a paste configuration.

5. The method of producing and administering a nutritional supplement including sunflower butter of claim 1, wherein said supplement includes a proportioned amount of said micro-nutrients according to an individual type in which to feed said supplement.

6. The method of producing and administering a nutritional supplement including sunflower butter of claim 5, wherein said individual type includes infants, children, young/middle aged adults, pregnant/breast feeding women and elderly adults.

7. The method of producing and administering a nutritional supplement including sunflower butter of claim 6, wherein said proportioned amount of said supplement is positioned within an individualized container.

8. The method of producing and administering a nutritional supplement including sunflower butter of claim 7, wherein said individualized container is comprised of a squeezable structure.

9. The method of producing and administering a nutritional supplement including sunflower butter of claim 7, including a family pack to contain a plurality of said individualized containers.

10. A method of producing and administering nutritional supplement including sunflower butter, comprising:
a supplement including a sunflower butter substance;
wherein said sunflower butter substance is mixed with various micro-nutrients within said supplement;
wherein said supplement comprises a substantial portion of a recommended daily allowance of food for an individual;
wherein said supplement includes sugar, maltodextrin, protein whey, fortified milk powder and fat and wherein said supplement includes various digestive enzymes and digestive aiding bacteria;
wherein said sunflower substance is comprised of a paste configuration;
wherein said supplement includes a proportioned amount of said micro-nutrients according to an individual type in which to feed said supplement;
wherein said individual type includes infants, children, young/middle aged adults, pregnant/breast feeding women and elderly adults;
wherein said proportioned amount of said supplement is positioned within an individualized container;
wherein said individualized container is comprised of a squeezable structure; and
a family pack to contain a plurality of said individualized containers.

11. A method of producing and administering a nutritional supplement including sunflower butter, comprising:
(a) heating fat to a first temperature;
(b) adding a first plurality of ingredients to said heated fat to form a first mixture;
(c) kneading said first mixture for a first predetermined time;
(d) adding a second plurality of ingredients to said first mixture to form a second mixture;
(e) kneading said second mixture for a second predetermined time;
(f) adding heated sunflower butter to said second mixture to form a supplement;
(g) kneading said supplement for a third predetermined time; and
(h) cooling said supplement.

12. The method of producing and administering a nutritional supplement including sunflower butter of claim 11, wherein said first mixture includes sugar, protein, vitamins, minerals and stabilizer.

13. The method of producing and administering a nutritional supplement including sunflower butter of claim 12, wherein said first mixture includes digestive enzymes.

14. The method of producing and administering a nutritional supplement including sunflower butter of claim 13, wherein said digestive enzymes include amulase, protease, lipase and cellulasse.

15. The method of producing and administering a nutritional supplement including sunflower butter of claim 13, wherein said first mixture includes digestive aiding bacteria.

16. The method of producing and administering a nutritional supplement including sunflower butter of claim 15, wherein said digestive aiding bacteria includes lactobacillus acidophilus, bifidobacterium bifidum, lactobacillus bulgaricus and streptococcus thermophilus.

17. The method of producing and administering a nutritional supplement including sunflower butter of claim 11, wherein said second mixture is comprised of fortified milk powder, whey and maltodextrin.

18. The method of producing and administering a nutritional supplement including sunflower butter of claim 11, wherein said heated sunflower butter is heated to a second temperature prior to adding said heated sunflower butter to said second mixture, wherein said second temperature is approximately 120 degrees Fahrenheit.

19. The method of producing and administering a nutritional supplement including sunflower butter of claim 11, wherein said first temperature is approximately 145 degrees Fahrenheit.

20. The method of producing and administering a nutritional supplement including sunflower butter of claim 11, wherein said cooled supplement is injected within a tube.
